(19) United States
(12) Patent Application Publication
(10) Pub. No.: US 2005/0086066 A1
(43) Pub. Date: Apr. 21, 2005

(54) Order status on-demand agent

(75) Inventor: Nitin Jhingan, Endwell, NY (US)

Correspondence Address: SCULLY SCOTT MURPHY & PRESSER, PC, 400 GARDEN CITY PLAZA, GARDEN CITY, NY, 11530, US

(73) Assignee: INTERNATIONAL BUSINESS MACHINES CORPORATION, Armonk, NY (US)

(21) Appl. No.: 10/687,896

(22) Filed: Oct. 17, 2003

(51) Int. Cl. G06F 17/60

(52) U.S. Cl. 705/1; 705/8

(57) ABSTRACT

Disclosed are a method and system for providing information about a requisition order. In the method an automated agent is provided for receiving and identifying a set of inquiries, and for each identified inquiry, preparing an associated response. A user transmits to the agent one of said set of inquiries, and the agent identifies the transmitted inquiry and prepares the associated response. An instant messaging system is used to send said associated response from the agent to the user. The preferred embodiment of the invention may be used to provide to the end user a status of orders and other information about their order quickly and concisely. Important advantages of using this rather than conventional web based solutions are the speed, simplicity and ease of use of this solution

### BACKGROUND OF THE INVENTION

1. Field of the Invention

This invention generally relates to methods and systems for providing and receiving information about requisition orders. More specifically, the invention relates to a procedure for using instant messaging to provide and receive such information over the Internet or other computer network.

2. Background Art

The Internet provides enormous opportunities for businesses, both for dealing with customers and clients and also for conducting internal operations. For example, requisitioning systems have been developed that allow businesses to use the Internet to prepare and process purchase or requisition orders that, if approved, are sent to suppliers.

In a requisition system, it is desirable that the individual who has submitted a purchase request or order have continuous, timely access to the status of the order. One challenge for an Internet based requisitioning system is to provide this access. This challenge is complicated by the fact that, in an Internet based system, a requisition order may be acted upon by a number of people in different parts of the world.

One way to provide status access is to use a Web interface. There are, though, a number of disadvantages to this approach. One important disadvantage is that, to use a Web based solution, the user must log on to the Web site, go through the profile creation process, navigate through the Web site to a search section, and then search for their order. This is time consuming and can be complicated or difficult for some users.

### SUMMARY OF THE INVENTION

An object of this invention is to provide an improved method and system for providing the status of requisition orders.

Another object of the invention is to provide quickly and concisely to an end user the status of requisition orders and other information abut their orders.

A further object of the present invention is to provide an Internet based solution that is quick, simple and easy to user for giving users access to the status of requisition orders.

These and other objectives are attained with a method and system for providing information about a requisition order. In the method an automated agent is provided for receiving and identifying a set of inquiries, and for each identified inquiry, preparing an associated response. A user transmits to the agent one of said set of inquiries, and the agent identifies the transmitted inquiry and prepares the associated response. An instant messaging system is used to send said associated response from the agent to the user.

The preferred embodiment of the invention, described in detail below, may be used to provide to the end user a status of orders and other information about their order quickly and concisely. Important advantages of using this rather than conventional web based solutions are the speed, simplicity and ease of use of this solution.

Further benefits and advantages of the invention will become apparent from a consideration of the following detailed description, given with reference to the accompanying drawings, which specify and show preferred embodiments of the invention.

### BRIEF DESCRIPTION OF THE DRAWINGS

FIG. 1 schematically illustrates a system embodying this invention.

FIG. 2 shows a computer workstation that may be used in the system of FIG. 1.

### DETAILED DESCRIPTION OF THE PREFERRED EMBODIMENTS

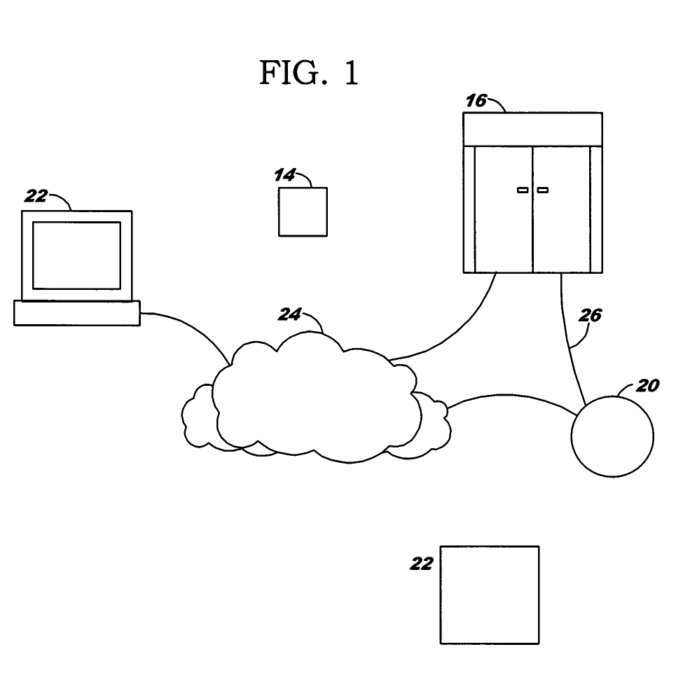

The present invention provides on demand order status using instant messaging. More specifically, with reference to FIG. 1, the invention relates to a method and system, using instant messaging, represented at 12, that provides information about requisition orders, represented at 14, that have been prepared and submitted a part of a requisitioning system, represented at 16.

In this invention, an automated agent 20 is created that has an identification that users, represented at 22, of the instant messaging system can add to their instant messaging address lists. The user can open a chat session with this agent, via the Internet 24, to learn of the status of, and other information about, the requisition order.

Instant messaging systems (IMSs) provide for instant, real-time communication between users who are connected to the system through an on-line or electronic networking environment. Examples of IMSs include Sametime, Yahoo! Messenger, and AOL Instant Messenger. (“Sametime” is a trademark of Lotus Development Corporation, “Yahoo” is a registered trademark of Yahoo! Inc., and AOL Instant Messenger is a service mark of America Online, Inc.) Such systems are becoming quite popular among users of networks such as the Internet, World Wide Web, and internal intranets because they are easy to use and provide a simple way for one user to send a message to another user.

IMSs provide real-time awareness of who is logged on. Typically, an IMS user has an address book containing names or nicknames for those people with whom he or she communicates. The entries in this address book are used for selecting a message recipient. The IMS typically indicates, using a visual cue (such as different icons or different fonts), which of the people are logged on to the system and which are not. For a message to be sent from a sending user to a receiving user, both users must be currently logged on to an IMS (which may be the same IMS, or a different IMS). Otherwise the system will not allow the sender to send the message. By ensuring that the receiver is available when a message is sent to him or her, the message can be delivered and presented to the recipient nearly instantly (depending on network delay).

In the present invention, a user 22 can initiate a chat session with agent 20 and ask questions about the status of a requisition order 14 and other questions about the order. For example, the user may ask: “What is the status of my order: XXXXX?” where XXXXX is the order number. The agent may respond with an answer such as “Your order is awaiting approval,” and the agent may provide the address of a Web site where the user can get more information.

Also, a user 22 may ask the agent: “Show my orders.” In response, the agent 20 returns to the user a list of order identifications for the user. As another example, the user may ask the agent to “Show the approvers of my order XXXXXX.” The agent may respond by sending to the user a list of approvers currently assigned to the order.

An application program interface (API) may be used to connect the agent 20 to the instant messaging system 12 so that the agent is seen as another user of that messaging system, and thus enables the user 22 and the agent 20 to communicate with each other via the instant messaging system. This API may be run on any suitable computer or computer system. In use, this API receives communications from the user 22, via the instant messaging system 12, and forwards those communications to the agent 20. Similarly, the agent sends messages and data to that API, which in turn sends those messages and data to the user 22 via the instant messaging system 12.

In addition, any suitable interface program may be employed to provide agent 20 with access to the requisitioning system 16. For example, this access may be provided by a Java Database Connection (JDBC) application program interface. Agent 20 may send requests for data to, and receive data from, requisitioning system 16 by utilizing such an interface.

In accordance with a second aspect of the invention, agent 20 helps the user 22 create orders through a chat window, eliminating the need to use a Website to create the orders. As an example, the user may enter the message “I want to order business cards.” The agent then asks the user “How many?” and the user provides an answer, for example “200.” The agent then asks or prompts the user for any additional needed information, such as their shipping address and accounting information, and then submits the order to the requisitioning system. The agent 20 may communicate with requisitioning system 16 via the Internet 24, or the agent may be directly connected to the requisitioning system, as represented at 26.

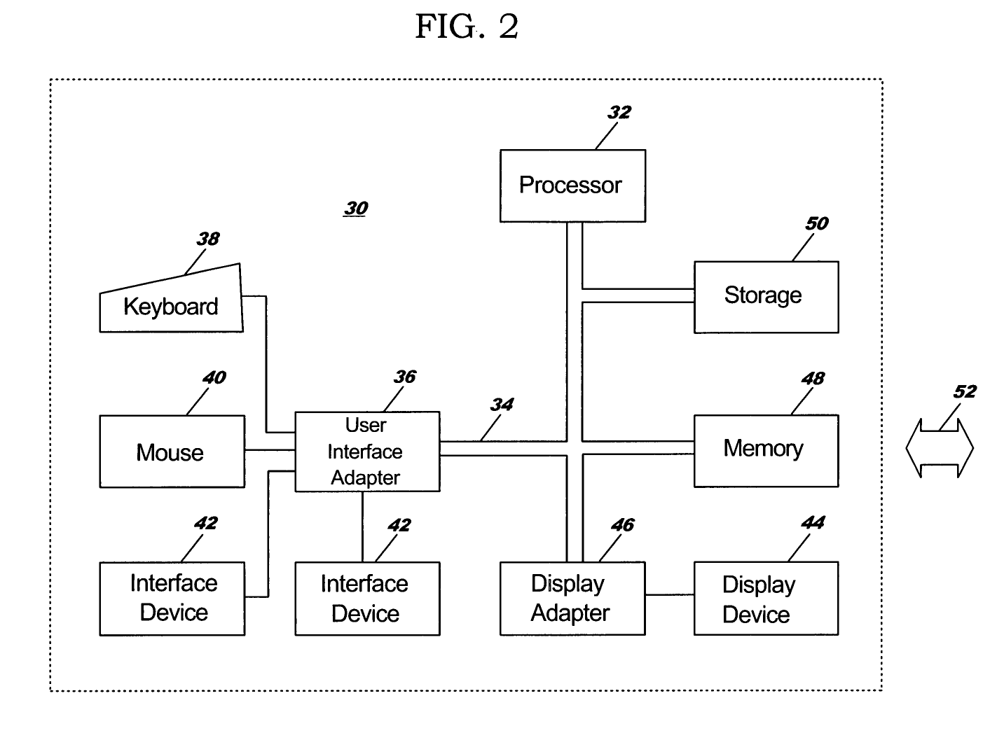

As will be understood by those of ordinary skill in the art, user may be provided with any suitable computer or workstation, and FIG. 2 illustrates a representative workstation hardware environment that may be used in the practice of this invention. The environment of FIG. 2 comprises a representative single user computer workstation 30, such as a personal computer, including related peripheral devices. The workstation 30 includes a microprocessor 32 and a bus 34 employed to connect and enable communication between the microprocessor 32 and the components of the workstation 30 in accordance with known techniques.

The workstation 30 typically includes a user interface adapter 36, which connects the microprocessor 32 via the bus 34 to one or more interface devices, such as a keyboard 38, mouse 40, and/or other interface devices 42, which can be any user interface device, such as a touch sensitive screen, digitized entry pad, etc. The bus 34 also connects a display device 44, such as an LCD screen or monitor, to the microprocessor 32 via a display adapter 46. The bus 34 also connects the microprocessor 32 to memory 48 and long-term storage 50 which can include a hard drive, diskette drive, tape drive, etc.

The workstation 30 may communicate with other computers or networks of computer, for example via a communications channel or modem represented at 52. Alternatively, the workstation 30 may communicate using a wireless interface, such as a cellular digital packet data (CDPD) card. The workstation 30 may be associated with such other computers in a local are network (LAN) or a wide area network (WAN), or the workstation 30 can be a client in a client/server arrangement with another computer, etc. All of these configurations, as well as the appropriate communications hardware and software, are known in the art.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

1. A method of providing information about a requisition order, comprising the steps:
providing an automated agent for receiving and identifying a set of inquiries, and for each identified inquiry, preparing an associated response;
a user transmitting to the agent one of said set of inquiries;
the agent identifying the transmitted inquiry and preparing the associated response; and
using an instant messaging system to send said associated response from the agent to the user.

2. A method according to claim 1, for use with a given requisition system, and further comprising the steps of:
the user preparing the requisition order and submitting the order to the requisition system; and
providing the agent with access to the requisition system to transmit information to and to receive information from the requisition system.

3. A method according to claim 2, further comprising the step of the agent, in response to identifying the transmitted inquiry, accessing the requisition system to obtain an answer to the transmitted inquiry.

4. A method according to claim 1, wherein the step of the user transmitting to the agent one of said set of inquiries includes the step of the user using the instant messaging system to transmit to the agent said one of the set of inquiries.

5. A method according to claim 1, wherein:
the step of the user transmitting to the agent one of said set of inquiries includes the step of the user transmitting to the agent a request to initiate preparation of the requisition order; and
the step of the agent preparing the associated response includes the step of the agent preparing a set of prompts to obtain information from the user about the requisition order; and
the step of using the instant messaging system includes the step of using the instant messaging system to send the set of prompts to the user.

6. A method according to claim 5, further comprising the steps of:
the user, in response to receiving the set of prompts, providing said information to the agent; and
the agent using said provided information to complete the purchase order, and sending the completed purchase order to a given requisition system.

7. A system for providing information about a requisition order, comprising:
an automated agent for receiving and identifying a set of inquiries, and for each identified inquiry, preparing an associated response;
a user station for transmitting to the agent one of said set of inquiries; wherein the agent identifies the transmitted inquiry and prepares the associated response; and
means connecting the agent to an instant messaging system to send said associated response from the agent to the user station.

8. A system according to claim 7, for use with a given requisition system and wherein a user prepares the requisition order and submits the order to the requisition system, the system further comprising means for providing the agent with access to the requisition system to transmit information to and to receive information from the requisition system.

9. A system according to claim 8, wherein the agent, in response to identifying the transmitted inquiry, accesses the requisition system to obtain an answer to the transmitted inquiry.

10. A system according to claim 7, wherein the user station uses the instant messaging system to transmit to the agent said one of the set of inquiries.

11. A system according to claim 7, wherein the user station transmits to the agent a request to initiate preparation of the requisition order, and wherein:
the agent includes means to prepare a set of prompts to obtain information from the user about the requisition order; and
the agent uses the instant messaging system to send the set of prompts to the user.

12. A system according to claim 11, wherein in response to receiving the set of prompts, the user provides said information to the agent; and wherein the agent includes:
means for using said provided information to complete the purchase order; and
means for sending the completed purchase order to a given requisition system.

13. A program storage device readable by machine, tangibly embodying a program of instructions executable by the machine to perform method steps for providing information about a requisition order, wherein an automated agent is provided for receiving and identifying a set of inquiries, and for each identified inquiry, preparing an associated response, and a user transmits to the agent one of said set of inquiries, said method steps comprising:
the agent identifying the transmitted inquiry and preparing the associated response; and
using an instant messaging system to send said associated response from the agent to the user.

14. A program storage device according to claim 13, for use with a given requisition system, and wherein the user prepares the requisition order and submits the order to the requisition system; and the method comprises the further step of providing the agent with access to the requisition system to transmit information to and to receive information from the requisition system.

15. A program storage device according to claim 14, wherein the method comprises the further step of the agent, in response to identifying the transmitted inquiry, accessing the requisition system to obtain an answer to the transmitted inquiry.

16. A program storage device according to claim 13, wherein the method comprises the further step of the user using the instant messaging system to transmit to the agent said one of the set of inquiries.

17. A program storage device according to claim 13, wherein the user transmits to the agent a request to initiate preparation of the requisition order, and wherein:
the step of the agent preparing the associated response includes the step of the agent preparing a set of prompts to obtain information from the user about the requisition order; and
the step of using the instant messaging system includes the step of using the instant messaging system to send the set of prompts to the user.

18. A program storage device according to claim 17, wherein the user, in response to receiving the set of prompts, provides said information to the agent, and the method comprises the further the steps of the agent using said provided information to complete the purchase order, and sending the completed purchase order to a given requisition system.

19. A method of providing information about a requisition order, comprising the steps:
providing an automated agent for receiving and identifying a set of inquiries, and for each identified inquiry, preparing an associated response;
using an application program interface for connecting the agent with an instant messaging system;
a user transmitting one of said set of inquiries utilizing the instant messaging system;
the agent receiving said one of the inquiries utilizing said application program interface;
the agent identifying said one of the inquiries and preparing the associated response; and
using the application program interface to send said associated response from the agent to the user via the instant messaging system.

20. A method according to claim 19, for use with a given requisitioning system, comprising the further step of using a database connection program to connect the agent with the requisitioning system and to enable the agent to send messages to and to receive data from said requisitioning system.

21. A method according to claim 20, wherein:
said one of the inquiries asks for specific information from the requisitioning system;
the step of the agent preparing the associated response includes the step of, the agent using the database connection program to access the requisitioning system to obtain said specific information; and
the step of using the application program interface to send the response to the user includes the steps of the agent sending said specific information to the application program interface, and said application program interface sending said specific information, via the instant messaging system, to the user.

22. A method according to claim 21, wherein said one of the inquiries asks for the status of a requisition order.
